(19) United States
(12) Patent Application Publication
(10) Pub. No.: US 2023/0314000 A1
(43) Pub. Date: Oct. 5, 2023

(54) SIMULATED ELECTRONIC FIREPLACE

(71) Applicants: Peter Merla, Grassie (CA); Marco Di Marco, Grassie (CA)

(72) Inventors: Peter Merla, Grassie (CA); Marco Di Marco, Grassie (CA)

(21) Appl. No.: 17/657,453

(22) Filed: Mar. 31, 2022

(51) Int. Cl. F24C 7/00; F24C 15/30; G06F 3/14

(52) U.S. Cl. CPC F24C 7/004; F24C 15/30; G06F 3/14

(57) ABSTRACT

A simulated electronic fireplace that is configured to be mounted in a wall wherein the present invention provides a graphical image of a fire and is further configured to produce and distribute heat. The present invention includes a housing having a display monitor on the front thereof. The display monitor is operably coupled to a controller wherein the controller is communicably coupled to a mobile computing device having a software application for operation of the simulated electronic fireplace installed thereon. The present invention includes facilitation through the software application an ability to select a desired image to be displayed on the display monitor and further provide monitoring of a data input stream. Data parameters of the data input stream are monitored for changes. Upon detecting a change in a data parameter the graphical image of the fire is temporarily altered and then returned to its original state.

### FIELD OF THE INVENTION

The present invention relates generally to interior home elements, more specifically but not by way of limitation, an electronic fireplace wherein the present invention includes a graphical display monitor configured to provide a life like image of a burning fire and that further includes heat production and is controllable via a software application.

### BACKGROUND

Millions of homes in the past were built with traditional wood burning fireplaces. These conventional fireplaces offered a unique design element to the home and provided the ability to burn a real wood fire and realize the aesthetic and functional benefits thereof. Current construction trends have changed due to code as well as consumer desire and now many homes are built either without fireplaces or the conventional fireplace has been replaced with gas or electric versions thereof. While these gas and electric fireplaces do provide functional heat, they are deficient in other aesthetic areas.

One issue with currently utilized gas and electric fireplaces is the lack of an aesthetically pleasing visual appearance. Many of these gas and electric fireplaces do not provide the flame production of a conventional wood burning fireplace and as such do not evoke the emotional response that many consumers are seeking. Electric fireplaces deploy an inferior reproduction of a fire that often deploys the use of a fan, red light and moving planar material shaped like flames. Gas fireplaces will deploy steel wool or other material to emulate glowing embers but do not produce a real lifelike image of a wood burning fire.

Accordingly, there is a need for an electric fireplace that provides the desired heat production but also provides a realistic image of a wood burning fireplace and is further configured to be manipulated and controlled by a software application on a mobile computing device.

### SUMMARY OF THE INVENTION

It is the object of the present invention to provide an electric fireplace that is configured to provide a lifelike image of a wood burning fire and heat production wherein the present invention includes a housing that is mounted within a wall of a room.

Another object of the present invention is to provide a simulated fireplace that is electric and configured to provide controllable images of a real wood burning fire wherein the housing of the present invention includes a display monitor.

A further object of the present invention is to provide an electric fireplace that is configured to provide a lifelike image of a wood burning fire and heat production wherein the present invention wherein the housing deploys heating elements on the sides, top and bottom thereof for heat production and further includes a fan to distribute the heat outward from the housing.

Still another object of the present invention is to provide a simulated fireplace that is electric and configured to provide controllable images of a real wood burning fire that further includes a controller disposed in the housing that is communicably coupled to a software application on a mobile computing device.

An additional object of the present invention is to provide an electric fireplace that is configured to provide a lifelike image of a wood burning fire and heat production wherein the present invention further includes sound production.

Yet a further object of the present invention is to provide a simulated fireplace that is electric and configured to provide controllable images of a real wood burning fire wherein the software application provides manipulation of the effects of the fire display such as but not limited to color and size.

Another object of the present invention is to a provide an electric fireplace that is configured to provide a lifelike image of a wood burning fire and heat production wherein the software application operably couples the fire display image with data streams being received by the mobile computing device such as but not limited to sports information data.

An alternate object of the present invention is to provide a simulated fireplace that is electric and configured to provide controllable images of a real wood burning fire wherein a change in the data parameters triggers a visual change in the fire displayed on the display monitor.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of an embodiment of the present invention and an exemplary portable computing device; and

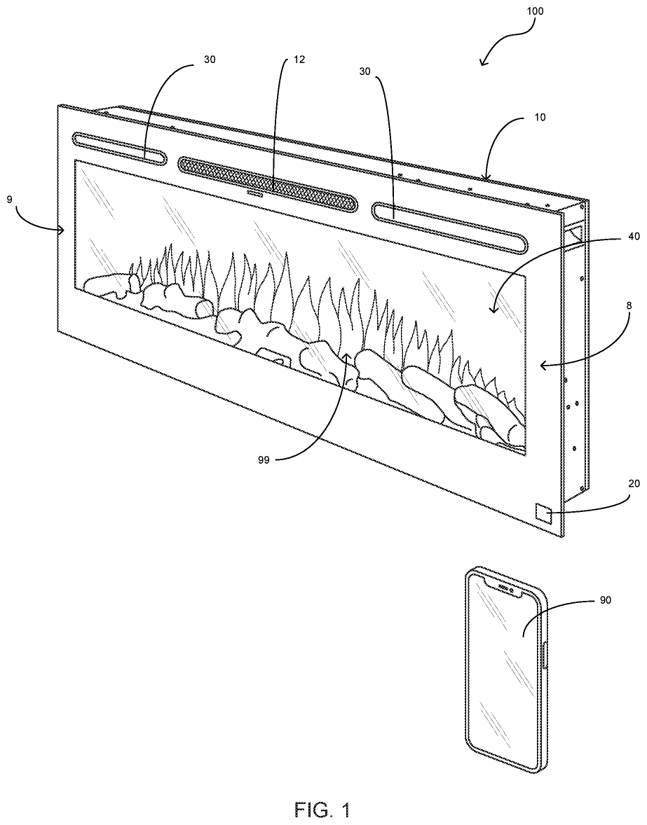

FIG. 2 is a flowchart of an exemplary method of use of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a simulated electronic fireplace 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring in particular to the Figures submitted herewith, the simulated electronic fireplace 100 includes a housing 10 wherein the housing 10 is manufactured from a suitable durable material such as but not limited to metal. While the housing 10 is illustrated herein as being rectangular in shape, it should be understood within the scope of the present invention that the housing 10 could be provided in alternate shapes and sizes. The housing 10 includes an interior volume wherein the interior volume has disposed therein a conventional heating element and fan (not particularly illustrated herein) so as to provide heat distribution via grill 12. The simulated electronic fireplace 100 further includes a controller 20 wherein the controller 20 includes the necessary electronics to receive, store, transmit and manipulate data. As is further discussed herein, the controller 20 is configured to communicably couple to the mobile computing device 90 that provides a user interface for operation of the simulated electronic fireplace 100.

The simulated electronic fireplace 100 further includes audio production members 30. The audio production members 30 are operably coupled to the controller 20 and are configured to produce sound as desired from the user of the simulated electronic fireplace 100. It should be understood within the scope of the present invention that the simulated electronic fireplace 100 could include alternate quantities of audio production members 30. The simulated electronic fireplace 100 includes display monitor 40. The display monitor 40 is operably coupled to the controller 20 and is a conventional graphic display monitor such as but not limited to a LED display monitor. The display monitor 40 extends intermediate the first end 8 and second end 9 of the housing 10. The display monitor 40 is configured to receive transmission from the controller 20 and display an image of an exemplary fire 99. It should be understood within the scope of the present invention that the image of the exemplary fire 99 is photographic imagery of a real fire in order to produce the desired aesthetic result for the simulated electronic fireplace 100. While an image of an exemplary fire 99 is displayed in the preferred embodiment, it should be understood within the scope of the present invention that the display monitor 40 is capable of displaying alternate images as programmed via the mobile computing device 90. While a particular size of the display monitor 40 is illustrated herein that substantially consumes most of the front of the housing 10, it is contemplated within the scope of the present invention that the display monitor 40 could be provided in alternate sizes.

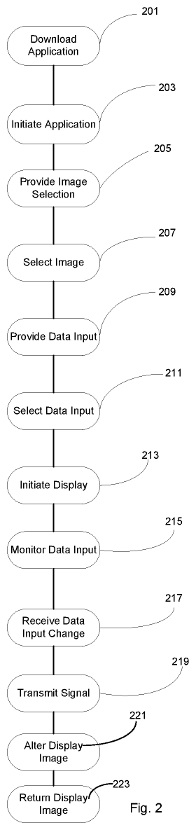

Referring now to FIG. 2 submitted as a part hereof, a flowchart of a method of the simulated electronic fireplace 100 is diagrammed therein. The method comprises step 201 wherein a user will download a software application to the mobile computing device 90. As is known in the art, software applications can be downloaded via the Internet or other conventional locations and/or techniques. In step 203, the user of the simulated electronic fireplace 100 will initiate the software application so as to commence operation of the simulated electronic fireplace 100. Step 205, the user is provided with a graphical screen wherein the graphical screen provides image selections of images to be displayed on the display monitor 40. In step 207, the user will select the graphical image that they desire to have projected via the display monitor 40.

In step 209, the software application provides a graphical screen that offers a multitude of data input streams of which one may be selected by the user. It should be understood within the present invention that in a preferred embodiment of the present invention that the data input streams are sports related, in particular a game being broadcast and available. It should be understood within the scope of the present invention that any sport or similar event could be made available for selection by the user. Step 211, the user will select a data input stream wherein the software application will initiate monitoring of the data input stream and in particular parameters associated therewith. It should be understood within the scope of the present invention that the parameters of the data input stream being monitored can include but are not limited to a score change, penalty or other similar data parameter associated with a sporting event.

In step 213, the software application will initiate the display of the selected image and transmit the information to the controller 20 wherein the controller 20 facilitates display of the selected image on the display monitor 40. Step 215, the software application continuously monitors the selected data input stream for changes in the data parameters associated therewith. In step 217, the software application detects a change in at least one of the data parameters of the data input stream being monitored. Step 219, the software application will transmit a signal to the controller 20 that a change in a data parameter of the data input stream being monitored has occurred. In step 221, the controller 20 will initiate a temporary change in the image being displayed on the display monitor 40. It should be understood within the scope of the present invention that any alteration of the image being displayed could be executed upon detection of a data parameter change. By way of example but not limitation, if a team of the sporting event being monitored scores the image being displayed on the monitor could be enlarged or altered to provide a visual effect to coordinate with the team scoring. It should be further understood within the scope of the present invention that the software application could include options to select only one team of a sport wherein the data parameters are monitored for that particular team and a change in the data parameters associated with the selected team would trigger an alteration in the displayed image. In step 223, ensuing alteration of the displayed image after a data parameter change, the displayed image is returned to its first state and the software application continues to monitor data parameters of the data input stream and will return the displayed image to its second state upon detection of a change in at least one of the data parameters. It should be understood that the software application facilitates any type of change to the displayed image to include but not be limited to enlargement, reduction and flickering.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A simulated electronic fireplace that is configured to produce a graphical image wherein the simulated electronic fireplace comprises:
a housing, said housing having a first end and a second end, said housing having an upper end and a lower end, said housing having a front side and a rear side, said housing having a plurality of walls formed to create an interior volume;
a controller, said controller having electronics operable to receive, store, transmit and manipulate data, said controller operable to facilitate operation of the simulated electronic fireplace, said controller communicably coupled with a mobile computing device;
a display monitor, said display monitor being disposed in said housing on said front side thereof, said display monitor operably coupled to said controller; and
wherein the simulated electronic fireplace is configured to display the graphical image in a first state and a second state.

2. The simulated electronic fireplace configured to produce the graphical image as recited in claim 1, and further including at least one audio production member, said at least one audio production member operably coupled to said controller, said at least one audio production member configured to emit audio.

3. The simulated electronic fireplace configured to produce the graphical image as recited in claim 2, wherein said controller is configured to monitor a data input stream having a plurality of data parameters, said controller operable to transition the graphical image from a first state to a second state.

4. The simulated electronic fireplace configured to produce the graphical image as recited in claim 3, wherein the graphical image is transitioned to a second state subsequent said controller receiving information of a change in at least one of said plurality of data parameters.

5. The simulated electronic fireplace configured to produce the graphical image as recited in claim 4, wherein the controller is operable to transition the graphical image back to the first state subsequent display of the graphical image in the second state.

6. The simulated electronic fireplace configured to produce the graphical image as recited in claim 5, wherein the graphical image is an image of a fire.

7. A method of operating a simulated electronic fireplace wherein the method comprises the steps of:
installing a simulated electronic fireplace in a wall, wherein the simulated fireplace includes a housing, said housing having a first end and a second end, said housing having an upper end and a lower end, said housing having a front side and a rear side, said housing having a plurality of walls formed to create an interior volume, said simulated electronic fireplace further including a controller, said controller having electronics operable to receive, store, transmit and manipulate data, said controller operable to facilitate operation of the simulated electronic fireplace, said controller communicably coupled with a mobile computing device and wherein the simulated electronic fireplace includes a display monitor, said display monitor being disposed in said housing on said front side thereof, said display monitor operably coupled to said controller;
downloading a software application, wherein a user of the simulated electronic fireplace downloads the software application to a mobile computing device;
initiating the software application;
presenting a plurality of images to the user, wherein the software application provides a plurality of graphical fire images to the user available for display on the display monitor;
selecting on of the plurality of images, wherein the user selects a graphical fire image to be displayed;
projecting the graphical fire image, wherein the graphical fire image is displayed on the display monitor;
providing a plurality of data input streams, wherein the software application provides to the user a plurality of data input streams to be monitored;
selecting a data input stream, wherein the user selects a data input stream to be monitored, wherein the data input stream comprises a plurality of data parameters;
monitoring the data input stream, wherein the software application monitors the plurality of data parameters of the data input stream;
detecting a change in one of the plurality of data parameters, wherein the software application detects a change in one of the plurality of data parameters of the data input stream;
transmitting a signal, wherein the software application transmits a signal to the controller subsequent detection of a change in one of the plurality of data parameters of the data input stream; and
changing the graphical fire image from a first state to a second state, wherein the controller changes the graphical fire image subsequent receipt of the signal.

8. The method of operating a simulated electronic fireplace as recited in claim 7, and further including the step of returning the graphical fire image to the first state, wherein ensuing displaying of the graphical fire image in the second state the graphical fire image is returned to the second state.

9. The method of operating a simulated electronic fireplace as recited in claim 8, and further including the step of producing an audio sound, wherein the simulated electronic fireplace produces a sound utilizing at least one audio production member.

10. The method of operating a simulated electronic fireplace as recited in claim 9, wherein said second state is a larger image than said first state.
